(19) United States
(12) Patent Application Publication
(10) Pub. No.: US 2024/0301742 A1
(43) Pub. Date: Sep. 12, 2024

(54) ACTUATOR

(71) Applicant: ASSA ABLOY NEW ZEALAND LIMITED, North Shore City (NZ)

(72) Inventors: Aayush Deep GYAWALI, North Shore City (NZ); Stuart HORWOOD, North Shore City (NZ)

(21) Appl. No.: 18/575,084

(22) PCT Filed: Jun. 28, 2022
(86) PCT No.: PCT/NZ2022/050084

§ 371 Date: Dec. 28, 2023

(30) Foreign Application Priority Data
Jun. 28, 2021 (NZ) 777688

(51) Int. Cl. E05F 15/627

(52) U.S. Cl. CPC E05F 15/627; E05Y 2201/11; E05Y 2201/656; E05Y 2600/626; E05Y 2900/148

(57) ABSTRACT

An actuator assembly comprising: a pivot bracket configured for mounting to a surface; an actuator base configured to be pivotally engaged with the pivot bracket; an actuator cover configured to couple to the actuator base; and an end cap configured to couple the actuator base to the pivot bracket via a friction fit or a threaded connection. A sash bracket for an actuator, the sash bracket comprising: a clip configured for attachment to a chain of an actuator; a body configured for attachment to a window sash; and a pin configured to releasably couple the clip to the body. A chain guide for an actuator, wherein the chain guide comprises a runner that fits with an elongate recess of the chain.

### CROSS REFERENCE TO RELATED APPLICATIONS

This application is a national stage application under 35 U.S.C. 371 and claims the benefit of PCT Application No. PCT/NZ2022/050084 having an international filing date of 28 Jun. 2022, which designated the United States, which PCT application claimed the benefit of New Zealand Patent Application No. 777688 filed 28 Jun. 2021, the disclosure of each of which are incorporated herein by reference.

### FIELD

This invention relates to one or more of an actuator, actuator assembly, a sash bracket for an actuator, and a chain guide for an actuator.

### BACKGROUND

Actuators are available in the marketplace and are used to open and close panels, such as windows, doors, and the like. Actuators can be mounted to a frame and extend and retract a chain that is attached to a sash to open and close the sash.

### SUMMARY

According to one example, there is provided an actuator assembly comprising: a pivot bracket configured for mounting to a surface; an actuator base configured to be pivotally engaged with the pivot bracket; an actuator cover configured to couple to the actuator base; and an end cap configured to couple the actuator base to the pivot bracket via a friction fit.

According to a second example, there is provided a sash bracket for an actuator, the sash bracket comprising: a clip configured for attachment to a chain of an actuator; a body configured for attachment to a window sash; a first pin configured to releasably couple the clip to the body; a second pin configured to releasably couple the clip to the body; two tabs, each tab being coupled to one of the first pin and the second pin; and a biasing member configured to bias the first pin and the second pin away from each other into respective coupling positions in which the first pin and the second pin couple the clip to the body; wherein the two tabs can be squeezed together, against the bias, to move the first pin and the second pin towards each other into respective release positions in which the first pin and the second pin do not couple the clip to the body; wherein the first pin and the second pin define a pivot axis and the clip is configured to pivot about the pivot axis.

According to a third example, there is provided a chain assembly for an actuator, the chain assembly comprising: a chain that is foldable; and a chain guide comprising an elongate runner disposed between the sides of an elongate recess that is formed in the middle of the chain and running along the length of the chain and further comprising an idler wheel engaging with and guiding the chain at a U-shaped bend when the chain is being folded.

According to a fourth example, the is provided an actuator assembly comprising: a pivot bracket configured for mounting to a surface; an actuator base configured to be pivotally engaged with the pivot bracket, the actuator base having a threaded protrusion; an actuator cover configured to couple to the actuator base, the actuator cover having a threaded protrusion; and a fastener having a threaded hole, the fastener being configured to screw onto the protrusions to couple the actuator base to the pivot bracket.

According to a fifth example, there is provided an actuator comprising: the actuator assembly of the first or fourth example; a chain configured to be attached to a window sash; and a motor configured to drive movement of the chain.

Embodiments may be implemented according to any one of the dependent claims 38 to 43, 45 to 46, 48 to 52, or 54 to 57.

### BRIEF DESCRIPTION

The accompanying drawings which are incorporated in and constitute part of the specification illustrate embodiments of the invention and, together with the general description of the invention given above and the detailed description of embodiments given below, serve to explain the principles of the invention.

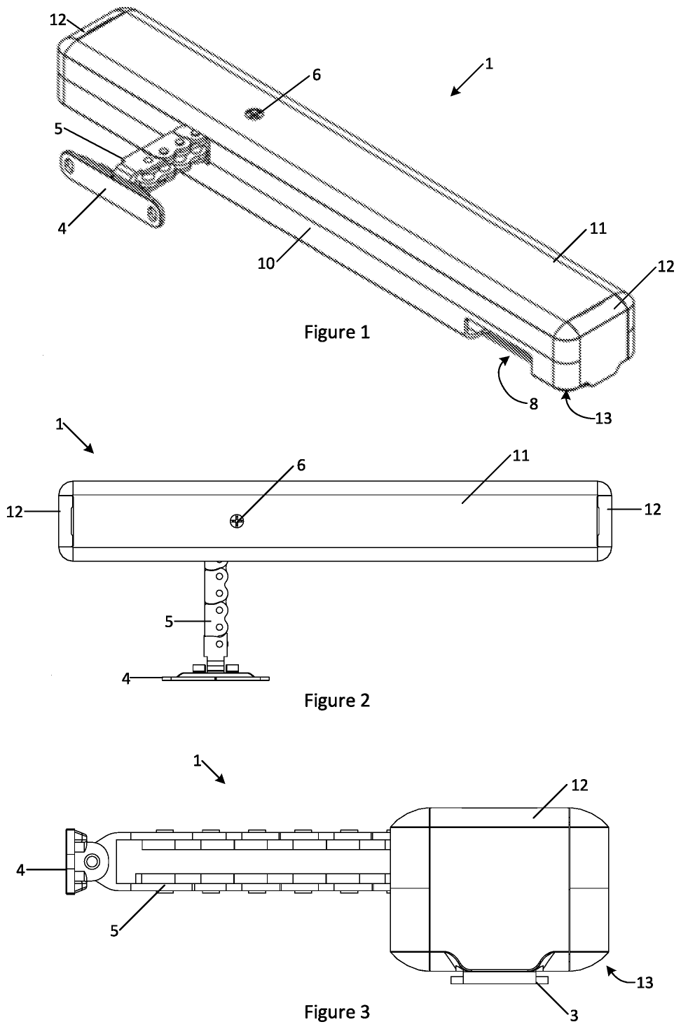

FIG. 1 is an isometric view of an actuator according to one example;

FIG. 2 is a top elevation of the actuator of FIG. 1;

FIG. 3 is a side elevation of the actuator of FIG. 1;

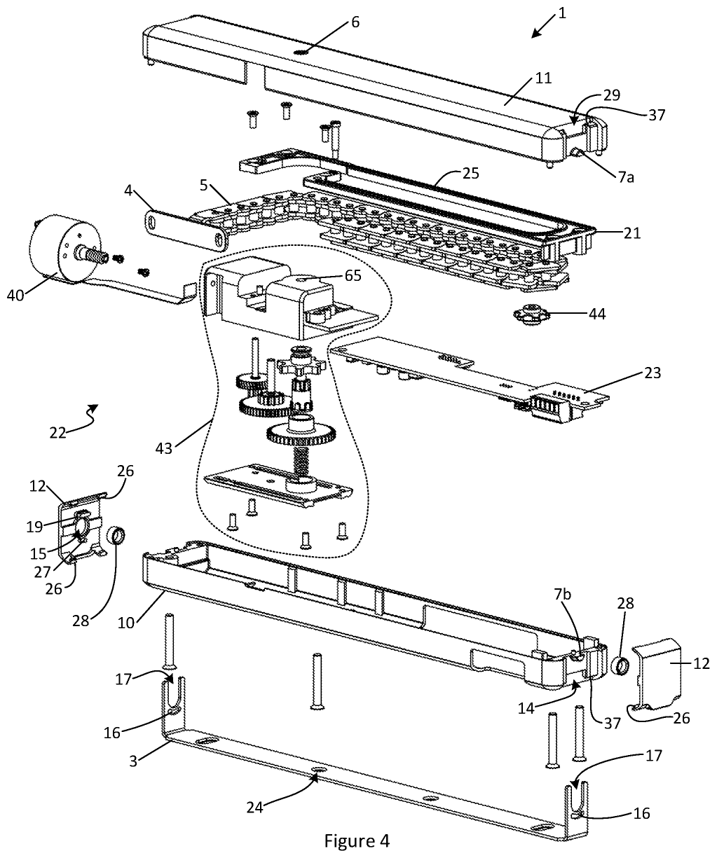

FIG. 4 is an exploded view of the actuator of FIG. 1;

FIG. 5A is an isometric view of a sash bracket according to one example;

FIG. 5B is another isometric view of the sash bracket of FIG. 5A;

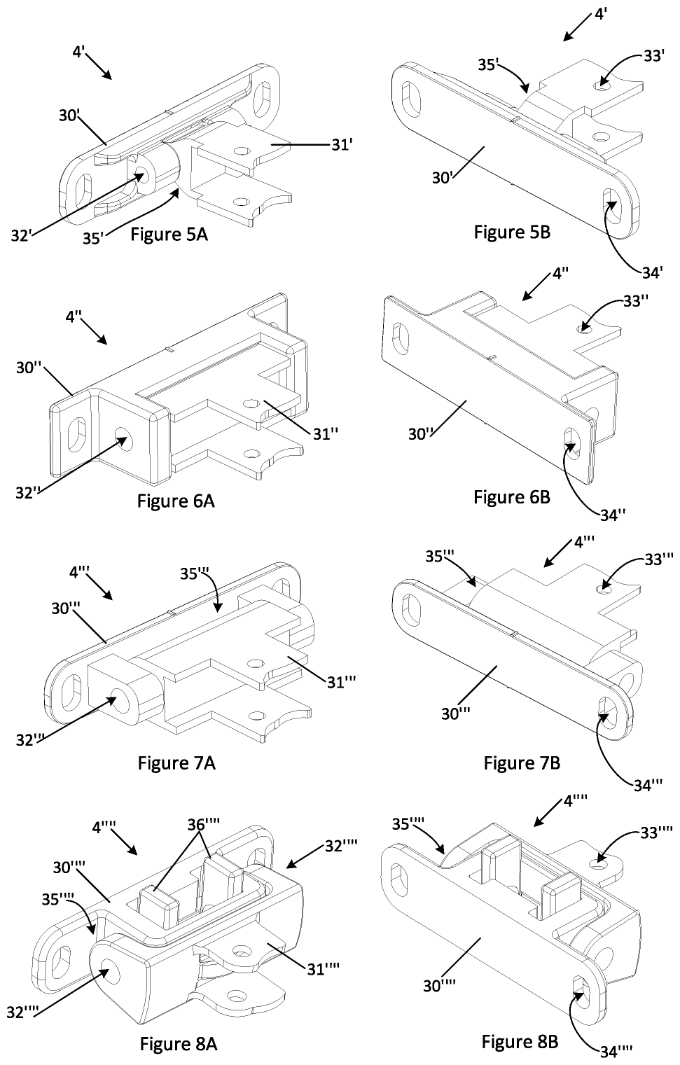

FIG. 6A is an isometric view of a sash bracket according to another example;

FIG. 6B is another isometric view of the sash bracket of FIG. 6A;

FIG. 7A is an isometric view of a sash bracket according to another example;

FIG. 7B is another isometric view of the sash bracket of FIG. 7A;

FIG. 8A is an isometric view of a sash bracket according to another example;

FIG. 8B is another isometric view of the sash bracket of FIG. 8A;

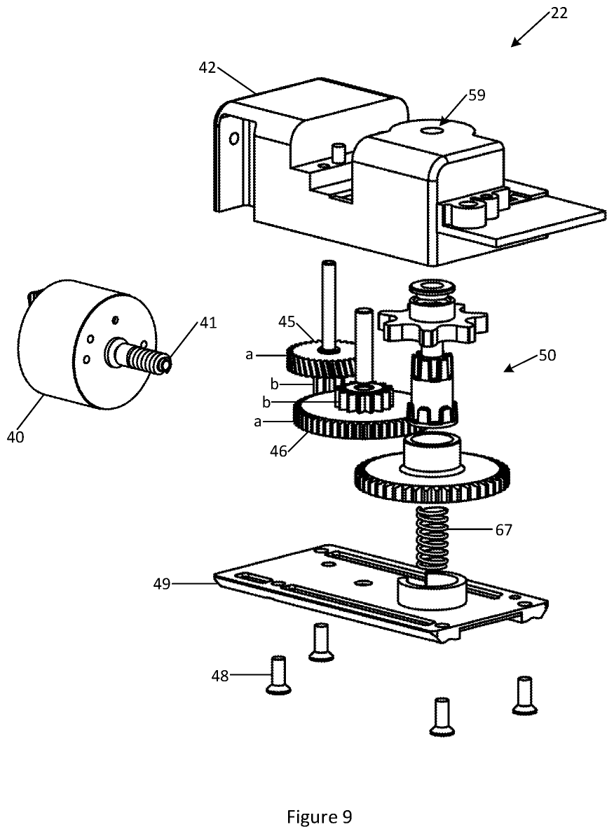

FIG. 9 is a partly exploded view of a chain drive according to one example;

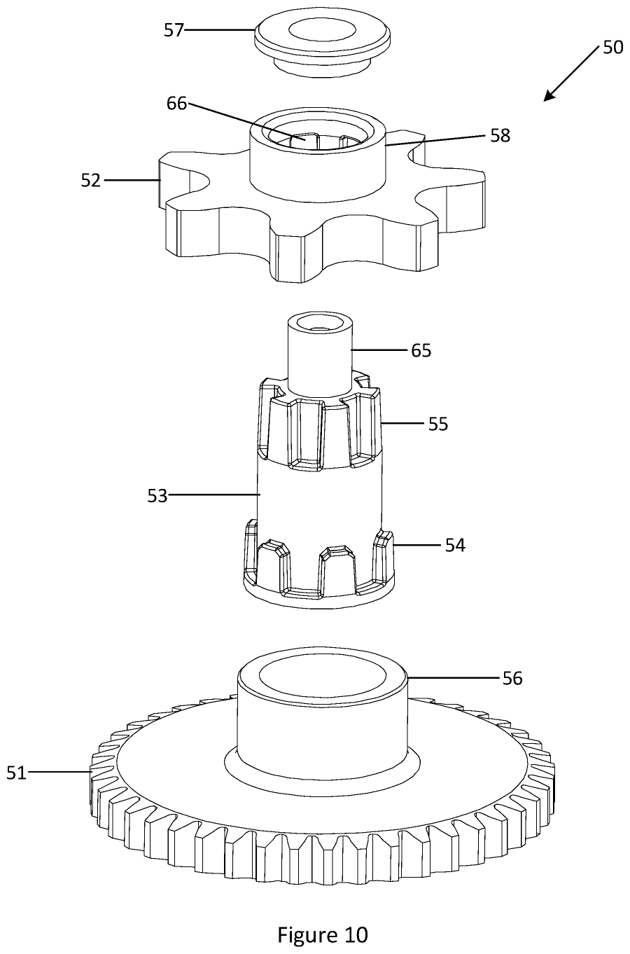

FIG. 10 is an exploded view of a clutch assembly according to one example;

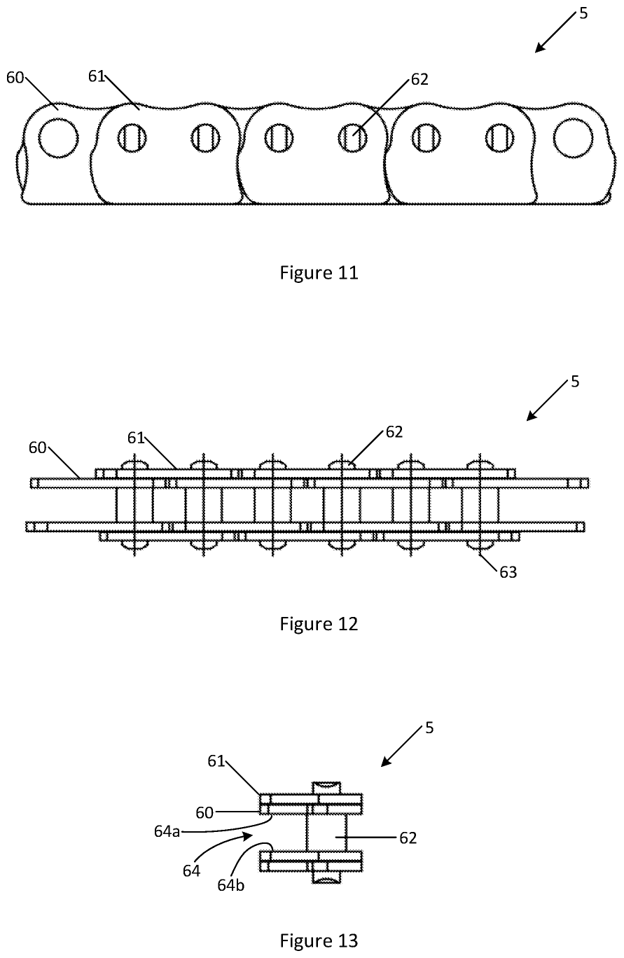

FIG. 11 is a top elevation of a section of chain according to one example;

FIG. 12 is a side elevation of the section of chain of FIG. 11; and

FIG. 13 is a front elevation of the section of chain of FIG. 11.

### DETAILED DESCRIPTION

Embodiments of an actuator will be described in the context of powered windows, with the actuator being mounted on a window frame and connected to a window sash by a sash bracket. However, in other implementations, the actuator may be used to actuate other building elements. For example, the actuator may be mounted on a door frame to open and close a door. In other examples, the actuator may be used to actuate skylights, shutters or air dampers. The mounting arrangement may also be reversed in some applications, with the actuator being mounted on a moved member such as a window and connected to a fixed member such as a frame by the sash bracket.

For convenience, the actuator is also described with reference to the orientation shown in FIG. 1, with FIG. 2 being the top elevation. The labels “top”, “side” and the like are relative to the actuator itself, not an external reference frame. The actuator can be installed and used in various orientations depending on the application and is not limited to use in any particular orientation or set of orientations.

FIGS. 1 to 3 illustrate an actuator according to an example. The actuator includes a base 10, a cover 11, a pivot bracket 3 and an end cap 12. The base 10, cover 11, pivot bracket 3 and end cap 12 together form an assembly that can be used to mount the actuator 1 to a surface. This assembly can also house components of the actuator such as a chain and chain drive components and is referred to herein as the body of the actuator.

The base 10 is pivotally connected to the pivot bracket 3 so that the base can pivot as the window is opened and closed through a range of angles. The cover 11 is coupled to the actuator base 10. The cover in this example is releasably coupled to the base so that it can be fully or partly removed to access components within the actuator. As will be detailed further with reference to FIG. 4, the base 10 is coupled to the pivot bracket 3 via a friction fit. In this example the end caps 12 are snap fit to the base 10 and cover 11. In an alternative example, the end caps may be screwed to the base by screw.

The end caps 12 also cover the points of engagement between the pivot bracket 3 and the base 10. As shown in FIGS. 1 and 3, the end cap 12 is visible at the side, with the pivot bracket 3 extending beneath the end cap 12 to the point at which it connects to the base 10. In some applications, it may be preferable that the point at which the pivot bracket connects to the base is not visible.

Because the end caps 12 extend further out to the side of the actuator 1 than the pivot bracket 3 (i.e. they lie “over” the pivot bracket at the side), they also obscure the pivot bracket 3 from view when viewed from the side opposite the frame to which the actuator is mounted—i.e. the top. As shown in the top view of FIG. 2, the pivot bracket is not viewable beneath the end caps 12. In some applications, it may be preferable that the pivot bracket is not visible when the actuator 1 is viewed from this side.

The base 10 has a rounded profile 13. This allows the base to be located close to the frame when installed without interfering with pivoting of the base 10 on the pivot bracket 3. As shown in the example of FIG. 1, the lower side of the base 10 is rounded in a plane orthogonal to the axis about which the base 10 pivots on the pivot bracket 3. The cover 11 and/or end caps 12 may also have a rounded profile to provide a consistent look with the base 10.

The actuator 1 has a chain 5 that transmits force to a window via sash bracket 4. The portion of the chain 5 that extends from the actuator body is relatively rigid in compression and tension to both push the window towards an open position and pull it towards the closed position. However, the chain 5 can be folded within the actuator body as will be detailed further with reference to FIGS. 4 and 11 to 13.

Also shown in FIGS. 1 to 3 is a cross-shaped aperture 6 in the cover 11. This is used to access and operate a clutch to disengage the chain 5 from a chain drive, allowing the chain 5 to be manually extended out from the body of the actuator 1 or retracted into the body of the actuator 1 without operating the chain drive.

An aperture 8 is also provided in the body of the actuator 1 for allowing the internal components (such as the printed circuit board assembly 23 of FIG. 4) to be accessed after assembly of the actuator 1. Power and/or data wires may enter the actuator body through the aperture. For example, a wiring harness with an end plug may be inserted through the aperture and plugged into the circuit board 23. A cover (not shown) may also be provided to cover the aperture 8.

The exploded view of FIG. 4 depicts components of the actuator 1 in more detail. In particular, the chain drive 22 (which includes motor 40 and gear box 43), chain guide 21 and circuit board assembly 23 are visible, as are the details of the connections between the base 10, cover 11, pivot bracket 3 and end caps 12.

The pivot bracket 3 can be a single bracket that mounts the main body of the actuator 1 at both ends of the actuator, rather than two separate brackets. The pivot bracket has an elongate central portion with a mounting portion at each end. In use, the elongate central portion would be attached to the surface (e.g. a window frame) and the mounting portions would project away from the surface, e.g. at about 90°. A bracket in this form can be particularly easy and fast to install. The elongate central portion can be easily visually aligned parallel to an edge of the surface (e.g. window frame) by eye, without the need for careful measurement and positioning of two separate mounts. This visual alignment is not practically achievable using other bracket designs that use two separate mounts. Having the two mounting portions connected to each other into a single bracket also means that the relative orientation of the two mounting portions is fixed by the structure of the bracket. This means that when the actuator is assembled the pivot axes at the ends of the actuator will naturally be aligned without the need to carefully control the relative orientations of two separate mounts. Having the pivot axes aligned reduces forces on mounting components such as the post 7. This may reduce component wear and extend the life of the actuator. The bracket can also be left on the surface during assembly and disassembly.

The base 10 and cover 11 each have an inset portion (14 and 29 respectively) at each end for receiving part of a pivot bracket 3 and an end cap 12. A partial post 7b is also provided on each end of the base 10. The partial post 7b on the base 10 and a partial post 7a on the cover 11 together form a cylindrical post 7 that fits snugly within a high-friction body 28 between the base 10 and the end cap 12. In alternative examples, a unitary post may be provided on the base 10 only. The high-friction body 28 extends through a cut out 17 in the pivot bracket 3 and into a recess 15 in the end cap 12 when the actuator is assembled. The base 10 and cover 11 also have recesses 37 for receiving protrusions 26 of each end cap 12. The protrusions and recesses form a snap fit coupling to snap fit the end caps 12 to the body of the actuator 1.

In other examples, one or more high-friction bodies may be attached to one or more of the end of the base 10, the end of the cover 11, or the end cap 12. In other examples, the high-friction body may be one or more blocks, bumps, or patches of a high-friction material. In some examples, the recess 15 may be formed in the end of the base 10, and possibly also the cover 11, with a post similar to the post formed by 7a and 7b being formed on the end cap 12.

In still other examples, the high-friction body may be excluded. For example, a friction fit or bearing may be formed by the surfaces of the pivot bracket 3 and one or both of the base 10 and end cap 12 being in direct contact.

When assembled, the cover 11 is placed on base 10. The base 10 and cover 11 can provide a housing of the actuator. The pivot bracket 3 is aligned with the base 10 and cover 11 with the cut-outs 17 within the inset portions 14 and 29. The high-friction washers 28 are placed over the posts (formed by 7a and 7b) and extend through the cut-outs 17. The end caps 12 are placed over this assembly with the high-friction washers 28 within the recesses 15 and the end caps 12 are snap fit into place.

The high-friction washers 28 fit closely on the post 7 (formed by 7a and 7b), forming a friction fit. The high-friction washers 28 may also fit closely in the cut-outs 17, providing additional friction. The actuator base 10 is thereby supported on the pivot bracket 3 by a friction bearing. The cover 11 is in turn supported on the base 10. The precise diameters of the post 7 and washers 28 (and possibly also the cut-outs 17) will depend on the level of friction desired in the friction fit. The skilled person will understand that the tightness of the friction fit will depend on the amount by which the diameter of the post 7 is less than the inner diameter of the friction washers 28 (and optionally also the amount by which the diameter of the cut-outs 17 is greater than the outer diameter of the high-friction washers 28). Because the actuator 1 is intended to pivot on the pivot bracket 3 in use, the friction bearing is designed to allow some rotational slip.

In alternative examples, the friction washer(s) could be replaced by (a) threaded fastener(s). The threaded fastener(s) would each have a threaded hole. In these examples, the corresponding post(s) 7 would have threaded exterior surfaces complementary to the threaded holes of the threaded fasteners so that the threaded fastener(s) can screw onto the posts. In particular, the partial posts 7a, 7b on the base 10 and cover 11 can each have partial threads on their rounded surfaces to form a continuous thread when brought together. The threaded fasteners may have rounded perimeters and may be round nuts. The threaded fasteners may thereby connect the base 10 to the cover 11.

Also provided on the end caps 12 are protrusions 19 and 27. The upper protrusion 19 extends into the cut-out 17 of the pivot bracket 3 when assembled. The lower protrusion 27 extends into a slot 16 in the pivot bracket 3 when assembled. The protrusions 19 and 27 move within the cut-out 17 and slot 16 when the actuator pivots on the pivot bracket up to a limit at which one or more protrusions is stopped by the side of the cut-out 17 or end of the slot 16.

This connection arrangement described above avoids the need to have fixture screws or the like passing through the cover. For example, some actuators have covers that are screwed onto their bases. These screws may be located on the “top” of the actuator (in the orientation of FIG. 1) where they are visible to a person near the window. In some applications, it may be preferable to not have several visible fixture screws or the like in the top of the actuator.

The connection arrangement described above may also provide a fast and simple way to remove or open the cover 11, e.g. for maintenance, repairs or inspection of the actuator 1. The upper protrusions 26 of the end caps 12 can be prised free from the recesses 37 of the cover 11, allowing the cover 11 to be removed or opened. The lower protrusions 26 can also be released from the base 10 and the end caps 12 removed. This can allow the actuator body to be easily removed from the pivot bracket 3, if desired.

In this example the protrusions 26 that snap fit the end caps 12 to the cover 11 are placed on the end caps 12 and the corresponding recesses 37 are formed in the cover 11. In alternative arrangements, one or all of the protrusions could be on the cover 11 with the corresponding recesses being on the end caps 12. Similarly, one or all of the protrusions 26 that snap fit the end caps 12 to the base could be on the base 10 with the corresponding recesses 37 being on the end caps 12.

In an alternative example, instead of snapping on using protrusions 26 and recess 37, the end caps 12 could slide into place on the base 10 and cover 11. In these examples, complementary elongate protrusions and recesses could be provided on end caps 12 and base 10 and cover 11. The end caps 12 could slide vertically down onto the base 10 and cover 11.

In this example there are two end caps 12 providing friction bearings at both ends of the actuator 1 and coupling the cover 11 to the base 10 at both ends of the actuator 1. In alternative examples, there may be a single such end cap at one end of the actuator. The bearing at the other end may be a low-friction bearing, as the friction provided at one end may be sufficient. The cover may be coupled to the base at that end by another means, such as a hinge allowing the cover to be hinged open when the cover is released by the end cap at the end opposite the hinge.

The pivot bracket 3 has attachment holes 24 along its length. In this example there are four such holes 24. This allows it to be attached to the surface at four different locations. In other examples, there may be 2, 3, 5 or more holes 24 for attaching at 2, 3, 5 or more fixture points along its length, respectively. This spreads the load of the actuator along the frame and helps to prevent the pivot bracket from rotating in the plane of the surface to which it is mounted.

The chain drive 22 is housed within the base 10 and cover 11 when they are assembled. This drives the chain 5 to extend from and retract into the body of the actuator 1. The chain drive 22 includes a motor 40 and a gear box 43. The top end of a clutch spindle 65 is visible protruding from the top of the gear box 43 in FIG. 4. This can be accessed via the aperture 6 when assembled, allowing the clutch to be operated by a user inserting a tool through the aperture 6 and depressing the clutch spindle 65.

The motor 40 is electrically connected to the printed circuit board assembly 23. This allows the motor 40 to receive power from the circuit board assembly 23. It may also be used to transfer data signals between the motor 40 and the circuit board assembly 23. For example, the circuit board assembly may receive signals indicative of back emf in an electric motor of the chain drive 22 to monitor motor speed.

The actuator 1 can also include an electronic restrictor for stopping the driving of the chain once it reaches a desired extension. In one example, an encoder is provided on the motor to measure an amount of motor rotation, which correlates to extension of the chain. When the motor has rotated in the opening direction by an amount that corresponds to the desired extension, this can be detected by processing circuitry on the PCB assembly. The processing circuitry will then stop the driving of the motor. The desired extension can be adjustable. For example, a switch can be provided on the actuator for selecting between different extension limits, such as 100 mm, 150 mm or 200 mm.

As shown in FIG. 4, part of the chain 5 is folded within the body of the actuator 1. This allows a relatively long length of chain 5 to be housed within a relatively small actuator body. The chain 5 is guided around the interior of the actuator 1 by chain guide 21. An idler wheel 44 is also provided to guide the chain 5. The chain guide 21 includes a long runner 25 that forms an inward projection of the chain guide 21. This is sized to fit within the recessed central portion (labelled 64 in FIG. 13) of the chain 5 that runs along its length. This may assist in keeping the chain 5 within the plane of the runner 25 (i.e. limiting the “vertical” excursion of the chain 5).

The chain guide 21 can be formed with relatively little material. The chain guide 21 can be moulded. This can make the chain guide 21 particularly simple and cost-effective to produce. Because the chain is supported and guided by the runner 25, the chain does not need to rest on a plate or housing (or between two such plates or parts of a housing). This may reduce friction between the chain and chain guide and may provide smoother operation. The chain guide is located on the outside of the folded chain. This may make the chain particularly robust against jamming during use. The end of the chain 5 can be attached to the gear box 43 such that a length of the chain 5 can be moved onto and off the guide without the chain coming fully free from the actuator.

Four exemplary sash brackets 4′, 4″, 4′″ and 4″″ are shown in FIGS. 5A, 5B, 6A, 6B, 7A, 7B, 8A and 8B. Each sash bracket includes: a body 30′, 30″, 30′″ or 30″″; a clip 31′, 31″, 31′″ or 31″″; and a pin (not visible in these Figures, location indicated by arrow(s) 32′, 32″, 32′″ or 32″″). The sash bracket 4″″ of FIGS. 8A and 8B has two such pins 32″″. The pin(s) can allow pivoting of the body with respect to the clip (and hence the chain) as the window is opened and closed. The clip is provided to attach to the chain of the actuator. The pin(s) is/are configured to releasably couple the clip to the body. The releasable attachment may make maintenance, installation, or replacement of the actuator simpler, faster and easier. For example, the chain (and clip) could be decoupled from the body to allow the body to be replaced or moved to a different location on the sash without needing to remove the actuator from the frame. Additionally, it could allow the window sash to be removed from the frame for repair or reglazing without the need to remove the actuator from the frame.

The pin may take different forms. In the exemplary sash brackets 4′, 4″ and 4′″ the pin includes a screw. The pin in these examples is inserted at 32′, 32″, 33′″, passes through the clip 31′, 31″, 31′″ and is screwed into the body 30′, 30″, 30′″ at the end beyond the clip. The far end of the pin would constitute the screw in this example. The pin may also have a plain (non-threaded) shank that sits within the clip.

In some exemplary bracket, the pin can be spring-loaded within the clip. In these examples, a spring would be provided in the clip to bias the pin “outwards” towards the position in which it engages with the body. When the pin is pressed “inwards” against the bias of the spring, it retracts into the clip to allow the clip to be released. Other than a spring, the bias may be provided by other biasing means such as a gas spring or elastic block. In these examples, there may be two pins—one extending out of each side of the clip into a respective portion of the body. To release the clip in such an example, a user would press both pins “inwards”.

In the exemplary bracket 4″″, there are two pins that are both spring-loaded within the body 30″″. These can be spring loaded by a single spring placed between the two pins. Two tabs 36″″ are also provided for releasing the pins from the clip 31″″. The tabs 36″″ are coupled to the pins—e.g. by being integrally formed with them, directly connected to them, or in contact with them-to transmit force from the tabs to the pins. When the tabs are squeezed together, the pins are retracted from the clip into the body to allow the clip to be released. As with the brackets discussed above, other biasing means than a spring may be used.

The sash bracket may be designed such that the clip can only be released from the body with the use of a special tool, with the application of a large force, or with the additional operation of a safety lock. This may prevent or hamper children or unauthorised people from detaching the sash bracket from the chain. It may also help to prevent the accidental release of the sash bracket from the chain. It may also ensure compliance with local regulations. For example, the screw-type pins of sash brackets 4′, 4″ and 4″″ may have specialised “anti-tamper” heads like those of anti-tamper screws. Alternatively, the head of each pin may be connected to the shank via a clutch plate and pressure plate that require the user to push hard longitudinally to transmit rotation from the head to the screw when removing it. In another example, the spring-loaded pin of sash bracket 4″″ may have a very strong biasing element such that a clamping tool or very strong manual squeeze would be required to release the clip. In another example, a lock could be provided on the sash bracket 4′, 4″, 4′″ or 4″″ that only allowed movement of the pin when unlocked with the correct key.

In use, the body is attached to a sash by screws passing through screw holes 34′, 34″, 34′″ or 34″″. For stability, one screw hole is provided on each side of the point at which the clip is coupled to the body. The clip is connected to the chain by a chain pin passing through holes 33′, 33″, 33′″ or 33″″.

The end 35′, 35″, 35′″ or 35′″ of the clip that is nearest the body is rounded in a plane orthogonal to the longitudinal axis of the pin(s). This ensures that the clip does not interfere with the body when it pivots about the pin(s).

FIGS. 9 and 10 show the chain drive 22 in more detail. An electric motor 40 drives a worm 41. In this example the motor 40 is a DC motor, although other motors may be used. This engages with and drives a worm gear 45a formed on the upper half of the compound gear 45. Compound gear 45 includes a smaller gear 45b on its lower half, which engages with and drives a larger gear 46a on the lower half of the compound gear 46. The smaller gear 46b on the upper half of the compound gear 46 drives the gear 51 (labelled in FIG. 10) of the clutch assembly 50.

As shown in the exploded view of FIG. 10, the clutch assembly 50 includes the gear 51, sprocket 52 and clutch shaft 53. The sprocket 52 engages with and drives the chain. The gear 51 releasably engages with the sprocket 52 via clutch shaft 53. The clutch shaft 53 includes lower splines 54 that are normally located within socket 56 of the gear 51 to engage with complementary splines (not visible in FIG. 10) within the socket 56 and transmit rotation from the gear 51 to the clutch shaft 53. The clutch shaft 53 also includes upper splines 55 that are normally located within the socket 58 of the sprocket 52 to engage with complementary splines 66 of the socket 58 and transmit rotation from the clutch shaft 53 to the sprocket 52. A spring 67 (shown in FIG. 9) is provided between the bottom of the clutch shaft 53 and the gear box cover 49 (shown in FIG. 9) to bias the clutch shaft 53 into its raised, engaged position. A bushing 57 is also provided at the top of the socket 58. The bushing 57 has a hole for the spindle 65 of the clutch shaft 53 to pass through. When assembled, the upper end of the spindle 65 sits within, and is accessible via, hole 59 in the support block 42 of the gear box. The gear box cover 49 attaches to the bottom of the support block 42 using screws 48 to house and retain in place the gears and the clutch assembly.

When assembled, the upper end of the spindle 65 sits in hole 59 in the support block 42 of the gear box and can be accessed via the aperture 6 shown in FIGS. 1, 2 and 4. The bushing 57 provides a bearing surface on the underside of the block 42.

As discussed above, the clutch shaft 53 is normally in its raised position and engaged with the gear 51 and sprocket 52. In this position, the splines 54 and 55 are engaged with the splines in the gear 51 and sprocket 52. This means that rotation of the gear 51 will be transmitted to the sprocket 52 to drive the chain and vice-versa. When a user inserts a tool through aperture 6 to lower the clutch shaft 53, the splines 54 move downwards out of the splines in the gear 51, disengaging the gear 51 from the sprocket 52. The chain can now be extended or retracted while the sprocket 52 and clutch shaft 53 spin freely.

Three views of the chain 5 are shown in FIGS. 11 to 13. The chain 5 is made up of outer links 61, inner links 60 and pins 62 that couple the outer links 61 and inner links 60 together in an alternating sequence. The pins can allow rotation about pin axes 63 so that the chain 5 can be turned through angles and folded within the actuator body. However, the portion of the chain 5 that extends from the body of the actuator to engage the window stays relatively rigid and does not bend majorly under compression. This type of chain is known as a rigid chain, with the actuator being known as a rigid chain actuator.

As shown in FIG. 13, a recess 64 is formed in the middle of the chain 5 and runs along its length. The runner 25 of FIG. 4 is dimensioned to fit within this recess 64 to assist in guiding the chain within the body of the actuator. Specifically, the runner can fit between the sides 64a and 64b of the recess, although part of the runner may lie outside the recess 64. Other suitable chain designs may be used.

### Interpretation

The term “comprises” and other grammatical forms is intended to have an inclusive meaning unless otherwise noted. That is, they should be taken to mean an inclusion of the listed components, and possibly of other non-specified components or elements.

While the present invention has been explained by the description of certain embodiments, the invention is not restricted to these embodiments. It is possible to modify these embodiments without departing from the spirit or scope of the invention.

1-36. (canceled)

37. An actuator assembly, comprising:
a pivot bracket configured for mounting to a surface;
an actuator base configured to be pivotally engaged with the pivot bracket;
an actuator cover configured to couple to the actuator base; and
an end cap configured to couple the actuator base to the pivot bracket via a friction fit.

38. The actuator assembly of claim 37, further comprising a high-friction body between the end cap and the actuator base.

39. The actuator assembly of claim 37, wherein one or more protrusions are provided on one of the end cap and the actuator base for engaging with one or more complementary recesses on the other of the end cap and the actuator base, and wherein one or more protrusions are provided on one of the end cap and the actuator cover for engaging with one or more complementary recesses on the other of the end cap and the actuator cover.

40. The actuator assembly of claim 37, wherein the end cap covers a point of engagement of the actuator base with the pivot bracket.

41. The actuator assembly of claim 37, wherein the pivot bracket is obscured from view when viewed from a side of a housing opposite a side at which the pivot bracket is configured to be mounted to the surface.

42. The actuator assembly of claim 37, wherein the pivot bracket is configured to be attached to the surface at a plurality of fixture points spaced apart along a length of the pivot bracket.

43. The actuator assembly of claim 37, wherein the pivot bracket is configured to pivotally engage with the actuator base at two opposite ends of the actuator base.

44. A sash bracket for an actuator, the sash bracket comprising:
a clip configured for attachment to a chain of an actuator;
a body configured for attachment to a window sash;
a first pin configured to releasably couple the clip to the body;
a second pin configured to releasably couple the clip to the body;
two tabs, each tab being coupled to one of the first pin and the second pin; and
a biasing member configured to bias the first pin and the second pin away from each other into respective coupling positions in which the first pin and the second pin couple the clip to the body;
wherein the two tabs can be squeezed together, against the bias of the biasing member, to move the first pin and the second pin towards each other into respective release positions in which the first pin and the second pin do not couple the clip to the body;
wherein the first pin and the second pin define a pivot axis and the clip is configured to pivot about the pivot axis.

45. The sash bracket of claim 44, wherein an end of the clip nearest the body is rounded in a plane orthogonal to a longitudinal axis of the first pin and the second pin.

46. The sash bracket of claim 44, wherein the body is configured to be attached to the window sash by screws, at least one screw being located on each side of a point of coupling of the clip to the body.

47. A chain assembly for an actuator, the chain assembly comprising:
a chain that is foldable; and
a chain guide comprising an elongate runner disposed between sides of an elongate recess that is formed in the middle of the chain and running along a length of the chain and further comprising an idler wheel engaging with and guiding the chain at a U-shaped bend when the chain is being folded.

48. The chain guide of claim 47, wherein the elongate runner lies substantially in a chain guide plane and wherein the elongate runner is configured to restrict movement of the chain out of the chain guide plane.

49. The chain guide of claim 47, wherein the chain guide is configured to prevent contact between the chain and a housing of the actuator.

50. The chain guide of claim 47, wherein the elongate runner is configured to enter the elongate recess from a side of the chain that is a radially outward side when the chain is folded within the actuator.

51. The chain guide of claim 47, wherein a proximal end of the chain is attached to a gear box.

52. An actuator assembly, comprising:
a pivot bracket configured for mounting to a surface;
an actuator base configured to be pivotally engaged with the pivot bracket, the actuator base having a threaded protrusion;
an actuator cover configured to couple to the actuator base, the actuator cover having a threaded protrusion; and
a fastener having a threaded hole, the fastener being configured to screw onto the threaded protrusions to couple the actuator base to the pivot bracket.

53. An actuator, comprising:
the actuator assembly of claim 37;
a chain configured to be attached to a window sash; and
a motor configured to drive movement of the chain.

54. The actuator of claim 53, further comprising an electronic restrictor configured to cause the motor to stop driving movement of the chain beyond a set extension of the chain.

55. The actuator of claim 54, wherein the set extension is adjustable and the electronic restrictor comprises a switch to set the extension of the chain.

56. The actuator of claim 54, further comprising an encoder associated with the motor and configured to output a signal indicative of an amount of rotation of the motor, wherein an electronic restrictor is configured to stop driving movement of the chain based on a comparison of the signal output by the encoder to the set extension of the chain.
